(19) United States
(12) Patent Application Publication
(10) Pub. No.: US 2002/0083464 A1
(43) Pub. Date: Jun. 27, 2002

(54) System and method for unprompted, context-sensitive querying during a televison broadcast

(76) Inventors: Mai-Ian Tomsen, Seattle, WA (US); Armando P. Stettner, Woodinville, WA (US); Martin L. Behrens, Bellevue, WA (US)

Correspondence Address: MADSON & METCALF, GATEWAY TOWER WEST, SUITE 900, 15 WEST SOUTH TEMPLE, SALT LAKE CITY, UT, 84101

(21) Appl. No.: 09/748,080

(22) Filed: Dec. 22, 2000

Related U.S. Application Data
(60) Provisional application No. 60/246,542, filed on Nov. 7, 2000.

(51) Int. Cl. G06F 3/00; H04N 5/445; G06F 13/00; H04N 7/173

(52) U.S. Cl. 725/112; 725/110; 725/43

(57) ABSTRACT

A user initiates an unprompted, context-sensitive request for supplemental content related to a television broadcast being displayed by an interactive television system. The information request includes an identification of the interactive television system and contextual information pertaining to the television program being viewed. The content source searches for supplemental content based upon the contextual information. If no supplemental content is found, a global information network, such as the Internet, is searched. The supplemental content is from the content source or the global information network to the interactive television system for display to the user.

### RELATED APPLICATIONS

The present application is related to and claims priority from U.S. provisional application No. 60/246,542, entitled “Systems and Methods for Viewer Trigger in Enhanced Television and Cable Operator Control over Enhanced Programming,” filed Nov. 7, 2000, with inventors Mai-lan Tomsen, Martin L. Behrens, and Armando P. Stettner, which is incorporated herein by reference in its entirety.

### BACKGROUND OF THE INVENTION

1. Field of the Invention

The present invention relates generally to the field of interactive television systems and, more particularly, to a system and method for unprompted, context-sensitive querying during a television broadcast.

2. Description of Related Background Art

Traditionally, the field of broadcasting relates to the activity of radio and television stations. However, with the development of cable and satellite networks, as well as the Internet, the meaning of the term has expanded to include the distribution of any type of media to many recipients using any transport method. For example, television and radio broadcasts are currently being sent by cable networks, satellite networks, packet switched networks, telephone networks, and conventional electromagnetic transmission techniques, e.g., radio frequency (RF) signals, very high frequency (VHF) signals, and ultra high frequency (UHF) signals.

Video streams for a television broadcast typically include a sequence of video frames or images that combine to form a moving image. Each video frame is referred to as a raster and includes a plurality of scan lines transmitted and displayed sequentially.

Cathode ray tubes (CRTs), as used in nearly all televisions and computer monitors, require a small amount of time for the scanning circuitry to return to the top of the screen after displaying the last line at the bottom of the screen. Video signal standards recognize this fact by inserting a number of “blank” lines at the beginning of each new video frame, which form a vertical blanking interval (VBI). During the VBI, the need to transmit video frame information is suspended and data can be encoded into the video stream, which can be decoded and extracted at the receiving end.

Video streams can be either analog or digital. Traditionally, television sets have displayed only analog video streams. However, digital televisions and digital video broadcasting techniques are growing in popularity.

With the development of various encoding algorithms, such as the Motion Picture Experts Group (MPEG) algorithm, digital video streams may be transmitted to, and displayed on, a variety of devices. Digital broadcasting algorithms typically divide the video stream into a sequence of data elements called “packets.” Each packet typically includes a header, which may be used to store information about the packet or the program to which it pertains.

Today, broadcast television and Internet technology is beginning to converge. In particular, access to the World Wide Web via Internet-enabled television systems is growing in popularity. However, conventional systems are not able to provide a true synthesis of broadcast and Internet media. In particular, conventional systems do not provide techniques for unprompted, context-sensitive querying for supplemental content related to a television broadcast. Supplemental content may include, for example, additional information about the television broadcast, images, streaming video, e-commerce opportunities, and the like.

Conventionally, the Advanced Television Enhancement Forum (ATVEF) standard provides a limited mechanism for obtaining supplemental content by embedding “triggers” in a television broadcast. Triggers allow content developers, broadcasters, or cable operators to insert prompts into the video stream when supplemental content is available to the viewer. This technique is described in more detail with respect to FIG. 4.

Unfortunately, ATVEF requires broadcasters or cable operators to embed specific triggers into the television broadcast. This is undesirable for a number of reasons. First, like advertisements, triggers have the tendency to distract viewers from the television broadcast and may actually annoy viewers. Second, many viewers would prefer to obtain additional information about a broadcast or access a commercial opportunity at a time of their own choosing, not merely when the broadcaster has chosen to embed a trigger. Third, triggers are typically not customized to individual viewers, but are broadcast to all of the viewers receiving a particular television program. As such, many triggers are never activated. Consequently, triggers consume valuable bandwidth that might be put to a more a productive use, such as the transmission of an electronic programming guide (EPG) or other useful information.

Accordingly, what is needed is a technique for unprompted, context-sensitive querying for supplemental content during a television broadcast. What is also needed is a technique for providing supplemental content related to a television broadcast that does not require a broadcaster or cable operator to embed specific triggers into the broadcast medium.

### SUMMARY OF THE INVENTION

The present invention solves the foregoing problems and disadvantages by providing a system and method for unprompted, context-sensitive querying in an interactive television system.

In one aspect of the invention, a user initiates an unprompted, context-sensitive information request by pressing a specifically-designated button on a remote control device for an interactive television system. The information request includes, in one implementation, an identifier of the interactive television system, which is used to route a set of search results back to the user.

The information request may also include contextual information concerning the television program or segment thereof being viewed. For example, the contextual information may include one or more of (1) an indication of a channel being displayed by the interactive television system, (2) a time index, (3) an indication of a specific television program being viewed, and (4) one or more keywords taken, for example, from close-captioning text associated with the television program.

The information request is sent from the interactive television system to a content source maintained, for example, by a broadcaster or cable operator. A search engine within the content source uses the contextual information from the information request to search the content source for supplemental content related to the television program being viewed. The output of the search engine is a set of search results comprising items of supplemental content related to the television broadcast.

In one embodiment, the information request also include a set of user preferences. The user preferences may be specified by the user or may be automatically generated based upon observed user behavior over time. The user preferences are used by the search engine, in one configuration, to filter the set of search results in order to produce manageable and personalized selections of related supplemental content for the user.

If related supplemental content is not found within the content source, a search may be performed of the Internet or another network. Thus, a broadcaster or cable operator need not anticipate a user's interest in order to provide supplemental content related to the television program. In one embodiment, the search of the Internet is performed using keywords or the like from the contextual information received in the information request.

If related supplemental content is identified within the content source, a set of search results is returned to the interactive television system for display to the user. The search results may be embodied as a set of links to the supplemental content, as well as short descriptions for display to the user.

In response to a user selecting an item of supplemental content from the search results, a selection indicator is returned to the content source. The content source, in turn, sends the selected item of supplemental content to the user for display by the interactive television system.

In one embodiment, the television program and the supplemental content are displayed simultaneously on the television screen, with the display of the television program being reduced in size relative to the display of the supplemental content.

These and other objects and features of the present invention will become more fully apparent from the following description and appended claims, or may be learned by the practice of the invention as set forth hereinafter.

### BRIEF DESCRIPTION OF THE DRAWINGS

Non-exhaustive embodiments of the invention are described with reference to the figures, in which:

FIG. 1 is a schematic block diagram of a system for delivering television programs and supplemental content to a plurality of users;

FIG. 2 is an illustration of an interactive television system including a remote control and a set top box;

FIG. 3 is a detailed schematic block diagram of a set top box;

FIG. 4 is a schematic block diagram of a television broadcast system based on embedded triggers;

FIG. 5 is a schematic block diagram of system for unprompted, context-sensitive querying;

FIG. 6 is a block diagram of an information request;

FIG. 7 is a schematic block diagram of content source processing of an information request;

FIG. 8 is a television screen layout for displaying search results provided in response to an information request;

FIG. 9 is a schematic block diagram of a system for unprompted, context-sensitive querying;

FIG. 10 is a television screen layout for displaying supplemental content simultaneously with a broadcast program; and

FIG. 11 is a flowchart of a method for initiating an unprompted, context-sensitive information request using an interactive television system.

### DETAILED DESCRIPTION OF THE PREFERRED EMBODIMENTS

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment.

Furthermore, the particular features, structures, or characteristics may be combined in any suitable manner in one or more embodiments. In the following description, numerous specific details are provided, such as examples of programming, user selections, network transactions, database queries, database structures, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

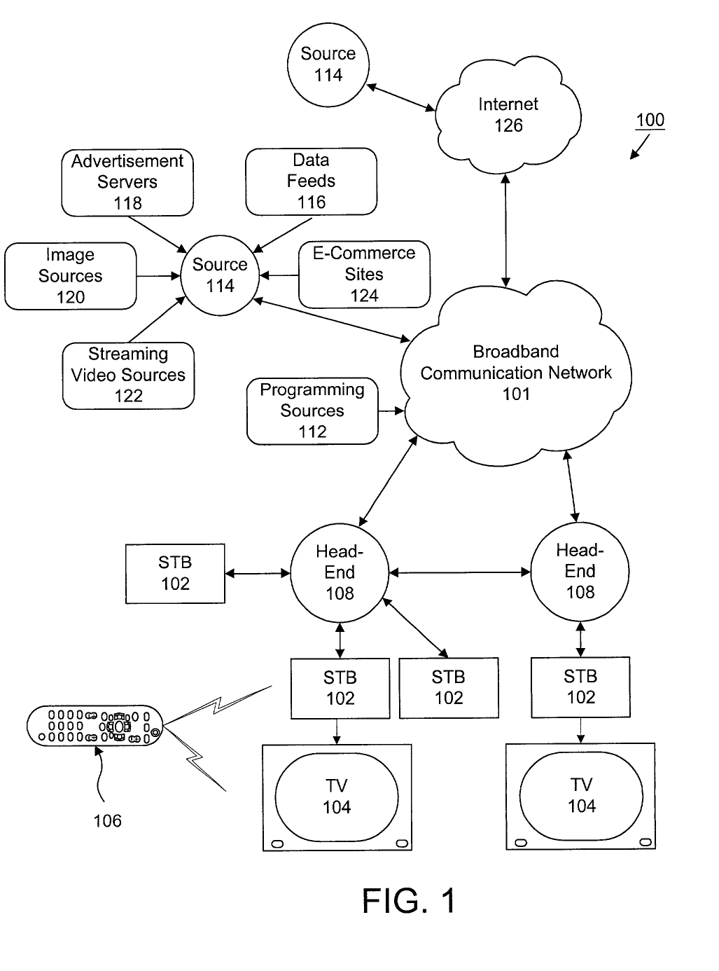

Referring now to FIG. 1, there is shown a system 100 for delivering television programs and supplemental content to a plurality of customers. In one implementation, the system 100 includes a broadband communication network 101, such as a cable network. However, other networks are contemplated, one particular example of which is a satellite network.

In one configuration, the system 100 includes a plurality of set top boxes (STBs) 102 located, for instance, at customer homes. Generally, an STB 102 is a consumer electronics device that serves as a gateway between a customer's television and the network 101. In alternative embodiments, an STB 102 may be embodied as a personal computer, an advanced interactive television set, or other type of client terminal.

In one embodiment, an STB 102 receives encoded television signals and other information from the network 101 and decodes the same for display on a coupled television 104 or other display device (such as a computer monitor, flat panel display, or the like). As its name implies, an STB 102 is typically located on top of, or in close proximity to, the television 104.

Each STB 102 may be distinguished from other network components by a unique identifier, number, code, or address, examples of which include an IP (Internet Protocol) address or media access control (MAC) address. Thus, video streams and other information may be transmitted from the network 101 to a specific STB 102 by specifying a corresponding address. The network 101 then routes the transmission to its destination using conventional techniques. The transmission uses various standard protocols, well known to those skilled in the art.

A remote control 106 is provided, in one embodiment, for convenient remote operation of an STB 102. The remote control 106 may use infrared (IR), radio frequency (RF), or other wireless technologies to transmit control signals to the STB 102. Other remote control devices are also contemplated, such as wired or wireless keyboards (not shown).

In one embodiment, each STB 102 is coupled to the network 101 via a head-end 108 or other distribution center. In the context of a cable network, a head-end 108 is a centrally-located facility where cable TV (CATV) channels are received from a local CATV satellite downlink and packaged together for transmission to customer homes. In one configuration, the head-end 108 also functions as a Central Office (CO) in the telephone industry, routing video streams and other data to and from the various STB 102 devices serviced thereby.

The network 101 is preferably coupled to one or more programming sources 112 for distributing primary content, such as television programs, to the STBs 102. Additionally, the network 101 is coupled to one or more supplemental content sources 114 (or simply “content sources 114”). As illustrated, the content sources 114 may include or be in communication with data feeds 116, advertisement servers 118, images sources 120, streaming video sources 122, and e-commerce sites 124, each of which may provide various types of supplemental content during a television broadcast.

Additionally, the network 101 is coupled to the Internet 126 in one embodiment. The Internet 126 is a “network of networks” and is well known to those skilled in the art. Communication over the Internet 126 is accomplished using standard protocols, such as TCP/IP (transmission control protocol/Internet protocol) and the like. In one embodiment, one or more content sources 114 may be accessible via the Internet 126.

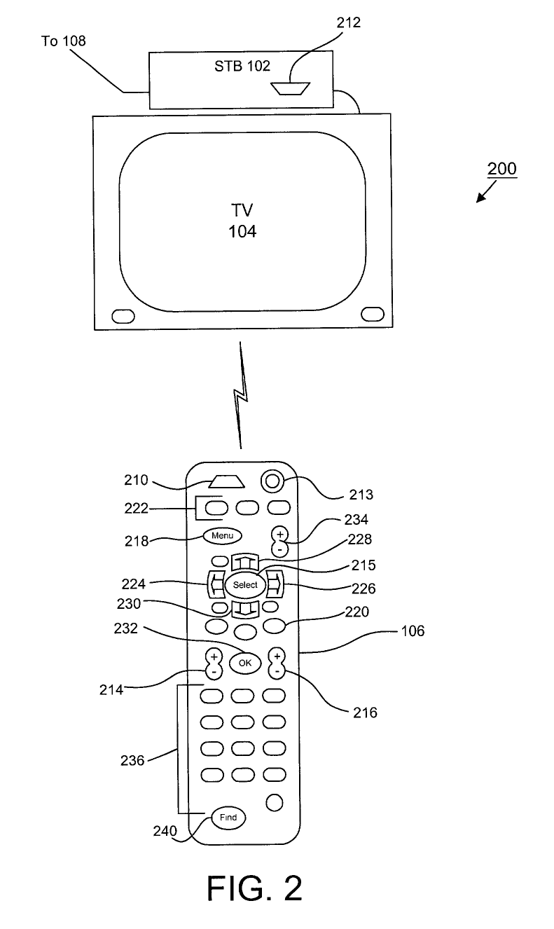

Referring now to FIG. 2, there is shown an interactive television system 200 according to an embodiment of the invention. The depicted system 200 includes an STB 102, a television 104, and a remote control 106. As noted above, the STB 102 is configured to send and receive video streams and other data to and from the network 101 via a head-end 108. In an alternate embodiment, the functionality of the STB 102 is integrated into an advanced version of the television 104.

The television 104 receives decoded television signals from the STB 102 and displays the same using conventional techniques. The television 104 may be embodied as a standard, analog television. Alternatively, the television 104 may be equipped to display a digital video stream.

The remote control 106 is provided for convenient remote operation of the STB 102 and the television 104. In one configuration, control signals are transmitted from a wireless transmitter 210 in the remote control 106 to a wireless receiver 212 in the STB 102 and television 104.

As shown in FIG. 2, the remote control 106 includes a plurality of buttons or similar controls. For example, the remote control 106 may include a power button 213, volume buttons 214, a “Select” button 215, channel buttons 216, a “Menu” button 218, an option button 220, device selection buttons 222, a left arrow button 224, a right arrow button 226, an up arrow button 228, a down arrow button 230, an “OK” button 232, increment and decrement buttons 234, various alphanumeric buttons 236, a “FIND” button 240, and the like.

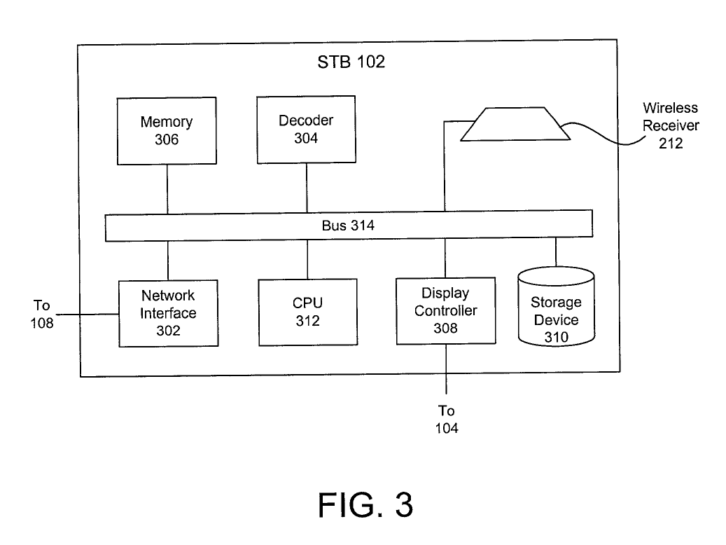

Referring now to FIG. 3, there is shown an expanded block diagram of an STB 102. As noted above, the STB 102 includes a wireless receiver 212 for receiving control signals sent by the wireless transmitter 210 in the remote control 106. In various embodiments, the receiver 212 may be configured to receive IR, microwave, VHF, UHF, or other frequencies.

The STB 102 also includes, in one implementation, a network interface 302 for communicating with the network 101 via the head-end 108. The interface 302 may include conventional circuitry, such as an MPEG tuner, for selectively receiving MPEG packets for a selected television channel. The interface 302 may also include conventional circuitry for receiving and transmitting other types of data. For example, the interface 302 may include DOCSIS or DAVIC modem circuitry.

In one configuration, one or more frequency bands (for example, from 5 to 30 MHz) may be reserved for upstream transmission. Digital modulation (for example, quadrature amplitude modulation or vestigial sideband modulation) may be used to send digital signals in the upstream transmission. Of course, upstream transmission is accomplished differently for different networks 101. Alternative ways to accomplish upstream transmission include using a back channel transmission, which is typically sent via an analog telephone line, ISDN, DSL, or other techniques.

In one implementation, the STB 102 also includes a decoder 304, such as an MPEG decoder, for decoding packets from the network 101 containing video streams and other information. As depicted, the decoder 304 may be implemented as a hardware component. Alternatively, or in addition, software decoding may be used.

The STB 102 further includes a memory device 306, such as a random access memory (RAM), configured to store data for temporary use. Similarly, a read-only memory (ROM) may be provided for storing more permanent data, such as fixed code and configuration information.

In one embodiment, a display controller 308 is provided for converting decoded digital video information into analog signals for display on the television 104. In alternative embodiments, the display controller 308 may provide direct, digital video output for televisions 104 equipped to receive the same.

In some implementations, the STB 102 may also include a storage device 310, such as a hard disk drive or the like. The storage device 310 may be configured to record television broadcasts and provide personal video recorder (PVR) functionality, such as pausing “live” television, providing personalized networks, and the like.

The storage device 310 may also be used to store viewer preferences, parental lock settings, electronic programming guide (EPG) data, programming preferences, passwords, e-mail messages, information requests, and the like. In one implementation, the storage device 310 also stores an operating system (OS) for the STB 102, such as Windows CE® or Linux®.

In various embodiments, a CPU 312 controls the operation of the STB 102, including the other components thereof, which are connected to the CPU 312 via a bus 314. The CPU 312 may be embodied as a microcontroller, a microprocessor, a digital signal processor (DSP) or other device known in the art. As noted above, the CPU 312 may perform these and other operations based on control signals generated by the remote control 106 and transmitted to the receiver 212.

Of course, FIG. 3 illustrates only one possible configuration of the STB 102. Those skilled in the art will recognize that various other architectures and components may be provided within the scope of the invention.

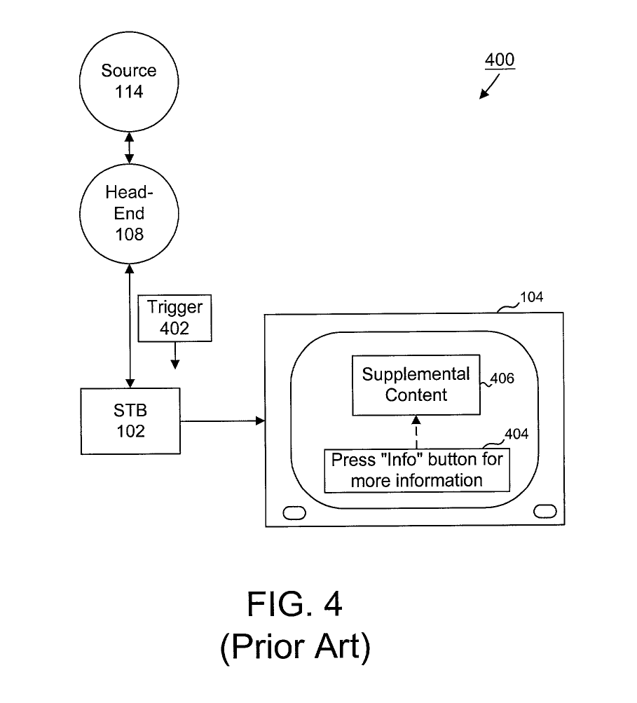

Referring now to FIG. 4, there is shown a conventional system 400 that relies on triggers 402 to provide supplemental content 406 during a television broadcast. As noted earlier, triggers 402 messages embedded by broadcasters, content developers, and/or cable operators into the broadcast medium. Various trigger protocols are known in the art, one example of which is the Advanced Television Enhancement Forum (ATVEF) protocol.

In general, triggers 402 are a mechanism for alerting television viewers to incoming content enhancements, e.g. supplemental content 406. Triggers 402 are sent over the broadcast medium and contain information about enhancements that are available to the viewer. Among other information, a trigger 402 typically contains a standard Universal Resource Locator (URL) that defines the location of the enhanced content. ATVEF content may be located locally (possibly delivered over the broadcast network 101 and cached to a hard drive) or it may reside on the Internet, another public network, or a private network.

As illustrated in FIG. 4, when a trigger 402 is received, the STB 102 automatically generates a message 404 on the user's television 104 to alert the user that the supplemental content 406 is available. A user may activate the trigger 402 by pressing, for example, a specifically-designated button on a remote control (not shown), such as an “Info” button.

Activating the trigger 402 causes the supplemental content 406 to be displayed. The supplemental content 406 may be received with the trigger 402. Alternatively, the trigger 402 includes a link, such as a URL, for retrieving the supplemental content 406.

Although triggers 402 allow broadcasters and cable operators to provide supplemental content 406, not every user desires enhanced features all of the time. Triggers 402, like advertisements, often distract users from the television broadcast and may actually annoy some users. Further, the supplemental content 406 is only available when triggers 402 are embedded in the broadcast. Users often prefer to obtain additional information about a broadcast or access a commercial opportunity on their own time schedule, not merely when the broadcaster has chosen to insert a trigger 402.

Furthermore, triggers 402 are typically sent to all of the viewers of the television broadcast. Accordingly, they cannot be customized for a particular user or context. For example, a particular user may only be interested in certain types of supplemental content 406, such as links related to the actors and actresses in the television program being viewed. However, a trigger-based system does not conventionally allow for this type of personalization. Not only are triggers 402 not customized to individual users, they are often not customized to the content of the program being viewed.

Finally, triggers consume valuable bandwidth that might be put to a more productive use, such as the transmission of an electronic programming guide (EPG) or other information. For the reasons discussed above, many triggers 402 are not activated, resulting in wasted bandwidth.

As an example, suppose a user is watching a news program discussing blight on geoducks and recommends that the viewers avoid them. The user has no idea what geoducks are and would like to obtain additional information. However, unless the broadcaster anticipated the user's interest, he or she cannot obtain the information using a conventional, trigger-based system. Moreover, if a trigger 402 is received, it is likely unrelated to geoducks, and is more likely e-commerce opportunity, which can be distracting and annoying. If the user elects not to activate the trigger 402, the bandwidth used for transmitting the trigger 402 was wasted.

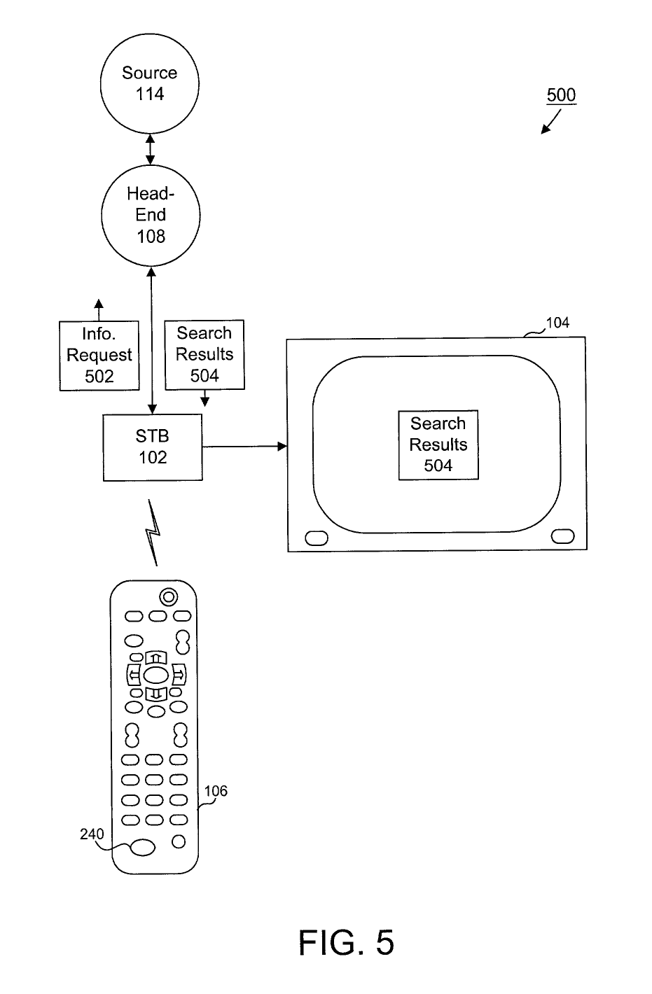

FIG. 5 is a schematic block diagram of a system 500 for providing supplemental content 406 related to a television broadcast that resolves the above-described problems and disadvantages. As described more fully hereafter, the depicted system 500 allows a user to send an unprompted, context-sensitive request for supplemental content 406 related to the television program (or segment thereof) being viewed. As used herein, supplemental content 406 may include a wide variety of information types, such as news feeds, advertisements, images, streaming video, and the like. Additionally, supplemental content 406 may include information and mechanisms for completing an electronic transaction.

It should be recognized that the system 500 is not incompatible with the system 400 of FIG. 4. For example, ATVEF triggers 402 may still be embedded in the broadcast medium. However, the present invention allows a user to obtain supplemental content 406 related to the television broadcast without the necessity of an embedded trigger 402.

In one embodiment, a user presses a “FIND” 240 button or the like on the remote control 106, which results in an appropriate control signal being sent to the STB 102. Upon receiving the control signal, the STB 102 generates an information request 502. Unlike conventional systems, the request 502 is unprompted, e.g., is not made in response to an embedded trigger 402. The information request 502 is preferably transmitted upstream by the STB 102 to a content source 114, which is maintained, for example, by a broadcaster, content producer, cable operator (MSO), or the like.

In certain embodiments, a content source 114 may be hosted within a head-end 108. However, for simplicity, the following description assumes that a head-end 108 and a content source 114 are separate entities, although the invention is not limited in this respect.

As described in greater detail below, the information request 502 contains contextual information from which the content source 114 may determine the television program (or segment thereof) being viewed. Based upon the contextual information, the content source 114 may search a database or the like and return a set of search results 504. In one embodiment, the set of search results 504 is a list of specific items of supplemental content 406 related to the television program (or segment thereof) being viewed. The list may include one or more links, such as URLs, identifying the stored location of the supplemental content 406. In an alternative embodiment, the search results 504 may actually include the supplemental content 406.

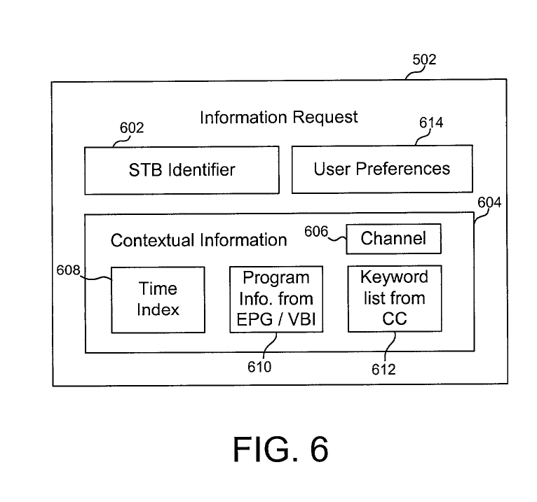

Referring now to FIG. 6, there is shown an exemplary format of an information request 502. While the information request 502 is depicted as including a number of different elements, it should be recognized that the request 502 may contain one or more of the illustrated elements.

In one configuration, the information request 502 includes an identifier 602 of the user's STB 102. The identifier 602 may be embodied in various forms, such as a media access control (MAC) address, an Internet protocol (IP) address, or another type of standard address known in the art. As described below, the content source 114 uses the identifier 602 to return the search results 504 to the correct STB 102.

In one embodiment, the information request 502 also includes contextual information 604 for indicating to the content source 114 which television program (or segment thereof) is being viewed. The contextual information 604 may include, for example, a channel identifier 606, which indicates to the content source 114 which channel the user is presently viewing.

A channel identifier 606 is a useful where the content source 114 stores supplemental content 406 with a course granularity. For example, a content source 114 may store items of supplemental content 406 applicable a television program as a whole, as opposed to discrete segments of the television program.

In one embodiment, the channel identifier 606 may be used to direct the information request 502 to a specific content source 114 related to the television program being displayed. For example, each content source 114 may be affiliated with a single broadcast channel, such as the Discovery Channel, CNN, or the like. In alternative embodiments, one content source 114 may service a plurality of broadcast channels, in which case the channel identifier 606 is valuable in identifying the television program currently being viewed.

Where the content source 114 stores supplemental content 406 of a finer granularity (e.g., directed to discrete segments of television programs), a time index 608 may be supplied in the information request 502. The time index 608 indicates, for example, the time that the user pressed the “FIND” button 240 or the time that the request 502 was sent.

Based upon the time index 608, the content source 114 may identify specific supplemental content 406 related to a discrete segment of the television program, such as a brief news segment related to geoducks. Supplemental content may be indexed according to time with varying degrees of granularity, such as by the minute or the second. Thus, if the user presses the “FIND” button during the geoducks news segment, supplemental content 406 pertaining to geoducks may be provided.

In alternative embodiments, a time index 608 is not sent with an information request 502. Rather, the content source 114 calculates a time index 608 based upon the time that the request 502 was received. In one embodiment, the content source 114 may take into account the amount of time required to transmit the request 502 from the STB 102 to the content source 114. Typically, this time is relatively small and may be disregarded. In some cases, however, the transmission time may be significant where the granularity of the supplemental content 406 stored for a particular television program is fine (e.g., measured in seconds rather than minutes).

In one implementation, the information request 502 contains an indication 610 of the specific television program being viewed. The indication 610 may be obtained, for example, from data encoded within the vertical blanking interval (VBI) of the television broadcast. Alternatively, the indication 610 may be obtained from electronic programming guide (EPG) data, which typically includes the name of the television program as well as other related data.

In the depicted embodiment, the request 502 may also include one or more keywords 612 obtained from closed-captioning text encoded with the television program. For example, when the “FIND” button 240 is pressed, the current page of closed-captioning text (and optionally one or more previous pages of text) may be transmitted along with the information request 502. Based upon the keywords 612 from the closed-captioning text, as described below, the content source 114 may search for supplemental content 406 related to the television program being displayed, even when the content source provider did not anticipate the user's interest by specifically including such content 406.

An information request 502 may also include, in one embodiment, a number of user preferences 614. The user preferences 614 may indicate, for instance, the types of supplemental content 406 that the user wishes to receive. For example, the user may indicate that he or she wishes to receive only supplemental content from a particular provider, such as a broadcaster. Likewise, the user may indicate that he or she wishes to receive only certain types of supplemental content 406, such as supplemental content 406 related to the actors and actresses of the television program being viewed. Furthermore, a user may indicate a desire to exclude certain types of supplemental content 406, such as e-commerce opportunities or advertisements. Thus, a wide variety of user preferences 614 may be specified to limit or expand the supplemental content 406 available to the user in response to an information request 502.

The user preferences 614 may also be based on historically observed behavior of the user, rather than user selections. For example, the STB 102 may note that the user only views supplemental content 406 related to actors and actresses and updates the user preferences 614 accordingly. Thus, in one embodiment, the search results 504 returned by the content source 114 may only include items of supplemental content 406 related to actors and actresses.

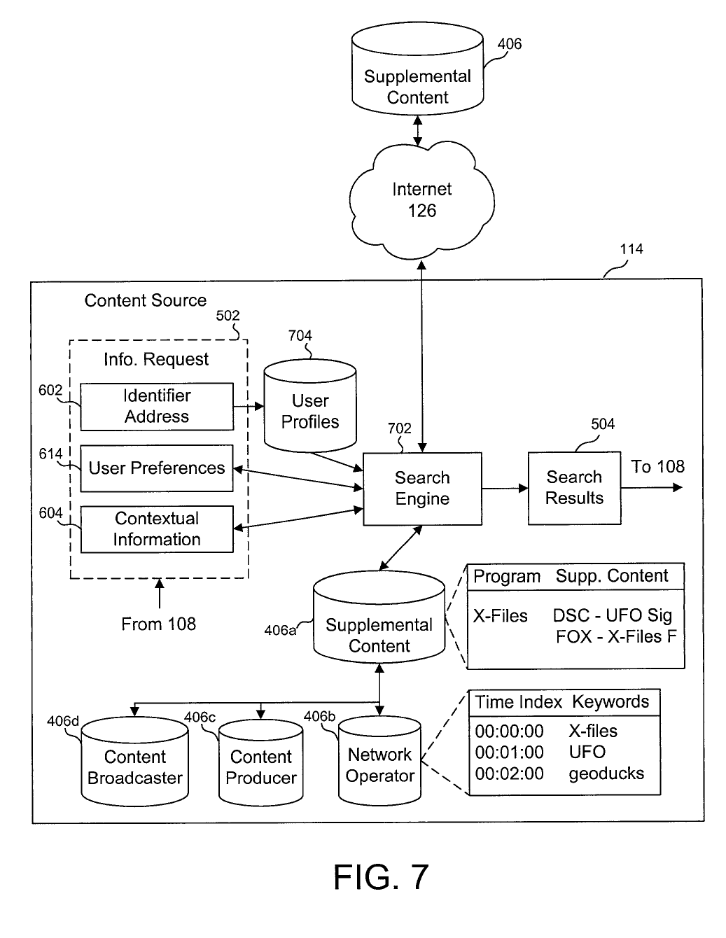

FIG. 7 is an expanded block diagram of a content source 114 according to an embodiment of the invention. In one implementation, the content source 114 includes a search engine 702 which receives the contextual information 604 and the user preferences 614 (if any) from the information request 502. The search engine 702 may be embodied as a database management system (DBMS), an Internet search engine, a metasearch engine, or other type of system or device for searching the content source 114 or the Internet 126 for supplemental content 406 satisfying the information request 502. Thus, the search engine 702 of FIG. 7 should not be limited to any particular technology.

As previously described and further illustrated in FIG. 7, the supplemental content 406 may be indexed with various granularities. For example, the set of supplemental content 406a stores supplemental content 406 on a per program basis. Thus, an entire television program, such as X-Files, is associated with a single set of supplemental content 406a. By contrast, the set of supplemental content 406b is indexed with a finer granularity, such as specific items of supplemental content 406 for each minute of the television broadcast.

In one embodiment, sets of supplemental content 406b-d may be provided by different sources, such as broadcasters, producers, or network operators. These sets of supplemental content 406b-d may be stored in separate searchable databases or locations. The search engine 702 may be configured, in one implementation, to search each of the different sets of supplemental content 406d-b in a prescribed order. Moreover, in one embodiment, a set of supplemental content 406 from one provider, e.g., a cable operator, may supersede supplemental content 406 available from another provider, such as a content broadcaster. Thus, in response to an information request 502, a user would only receive the supplemental content 406 from the cable operator and be unaware of the supplemental content 406 available from the broadcaster.

In one implementation, if no supplemental content 406 is found at the content source 114 that satisfies the information request 502, the search engine 702 may search the Internet 126 or another network. In various embodiments, the search engine 702 may, itself, utilize a different search engine, such as an Internet-accessible search engine or metasearch engine, to perform a search of the Internet 126.

In such a embodiment, the availability of keywords 612 from the closed-captioning text is advantageous, since the keywords 612 may be used by the search engine 702 (or other search engine) to perform a search of the Internet 126. The Internet 126 may also be searched using other forms of contextual information 604 found in the information request 502, such as the program indication 610 derived from EPG or VBI data.

As explained above, there is typically more supplemental content 406 relating to the information request 502 than is convenient to report to the user. As such, a heuristic filtering process of the search results 504 may be performed based, in part, on the user preferences 614 sent with the information request 502.

In addition, the filtering process may be based on selected or historical user preferences stored at the content source 114 in the form of user profile 704. A set of user profiles 704 may be indexed by, and accessed using, the STB identifier 602 received with the information request 502. Thus, the content source 114 may retrieve the correct user profile 704 and apply user preferences contained therein to filter the search results 504.

After the search engine 702 (or a separate filtering component) filters the search results 504, the search results 504 are sent to the head-end 108 for transmission to the user's STB 102, as identified by the STB identifier 602 in the information request 502.

In an alternative embodiment, the search results 504 are not filtered at the content source 114. Rather, the unfiltered search results 504 sent to the STB 102, after which the STB 102, itself, performs filtering based upon stored user preferences 614. In such an embodiment, there would be no need to send the user preferences 614 with the information request 502.

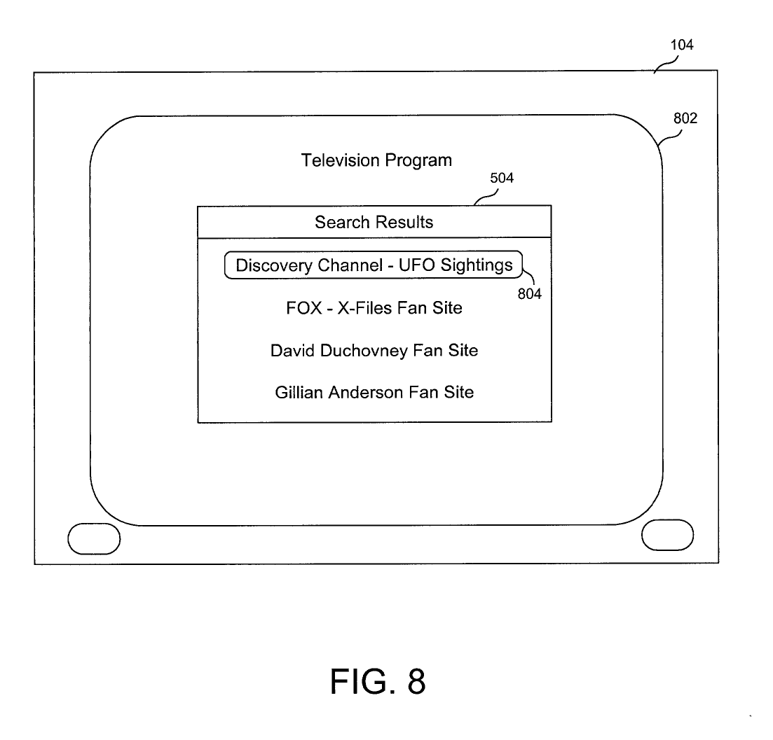

As shown in FIG. 8, the search results 504 are then displayed on the television 104 simultaneously with, or in place of, the television program 802 being viewed. As noted above, the search results 504 may be embodied as a list of items of supplemental content 406, which may take form of short descriptions of the items together with links (not shown) to the stored supplemental content 406. This may be accomplished, for example, using documents encoded in a markup language, such as the hypertext markup language (HTML).

In one embodiment, the search results 504 are displayed in a window that overlays part or all of the television program 802. In an alternative embodiment, however, the display area of the television 104 may be split between the television program 802 and the search results 504, such that both are simultaneously visible.

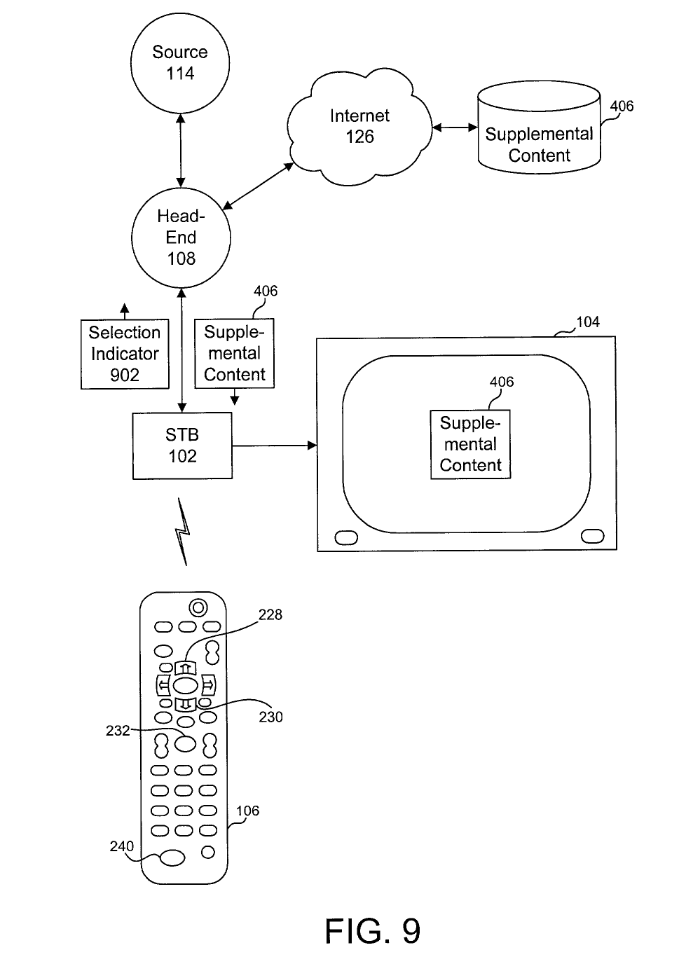

The items of supplemental content 406 are preferably selectable by the user. For example, referring also the FIG. 9, the user may select one of the items of supplemental content 406 by moving a selection rectangle 804 up and down in the search results 504 by means of the up and down arrow buttons 228, 230 of the remote control 106. When the selection rectangle 804 is placed over the desired item of supplemental content 406, the user may indicate his or her selection by pressing a “OK” button 232 or the like.

In one embodiment, pressing the “OK” button 232 causes a selection indicator 902 to be sent to the content source 114 for indicating the user's selection. The selection indicator 902 may be embodied as a link, such as a URL, or other indication of the selected item of supplemental content 406. In response to the selection indicator 902, the content source 114 sends the supplemental content 406 to the STB 102 for display on the television 104.

The selected supplemental content 406 may not always be stored at the content source 114. For example, the supplemental content 406 may have been located in response to a search of the Internet 126. Accordingly, in one embodiment, the selection indicator 902 comprises a URL that references the supplemental content 406 within the Internet 126. The supplemental content 406 may be retrieved by the STB 102 using conventional protocols, such as the hypertext transfer protocol (HTTP), the file transfer protocol (FTP), or the like.

As previously noted, the supplemental content 406 may be sent with the search results 504, in certain embodiments, and cached within the storage device 310. This may occur, for example, where the items of supplemental content 406 are relatively small. In such an embodiment, there is no need to send a selection indicator 902 to a content source 114 or the Internet 126. Rather, the selected supplemental content 406 may be retrieved from storage device 310 and displayed on the television 104.

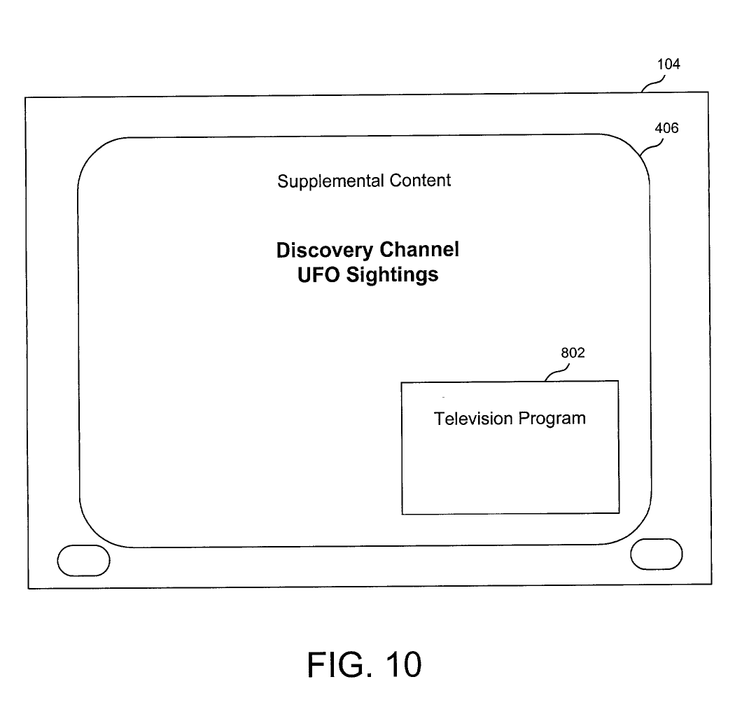

In one embodiment, as shown in FIG. 10, the full-size display of the television program 802 shrinks in an “animated” fashion (i.e. with visible motion to a viewer) to occupy a reduced-size area of the television 104, while the display of the supplemental content 406 occupies the remainder of the screen. This is advantageous since the user can still watch the television program 802, while the text of the supplemental content 406 (if any) is made as large as possible to be readable on the television 104.

Preferably, the user may interact with the displayed supplemental content 406, such as following links to display additional supplemental content 406, completing an electronic transaction, and the like. In one embodiment, pressing a “return” or “switch” button (not shown) on the remote control 106 allows the user to enlarge the broadcast program 802 to is original size, overlaying the supplemental content 406.

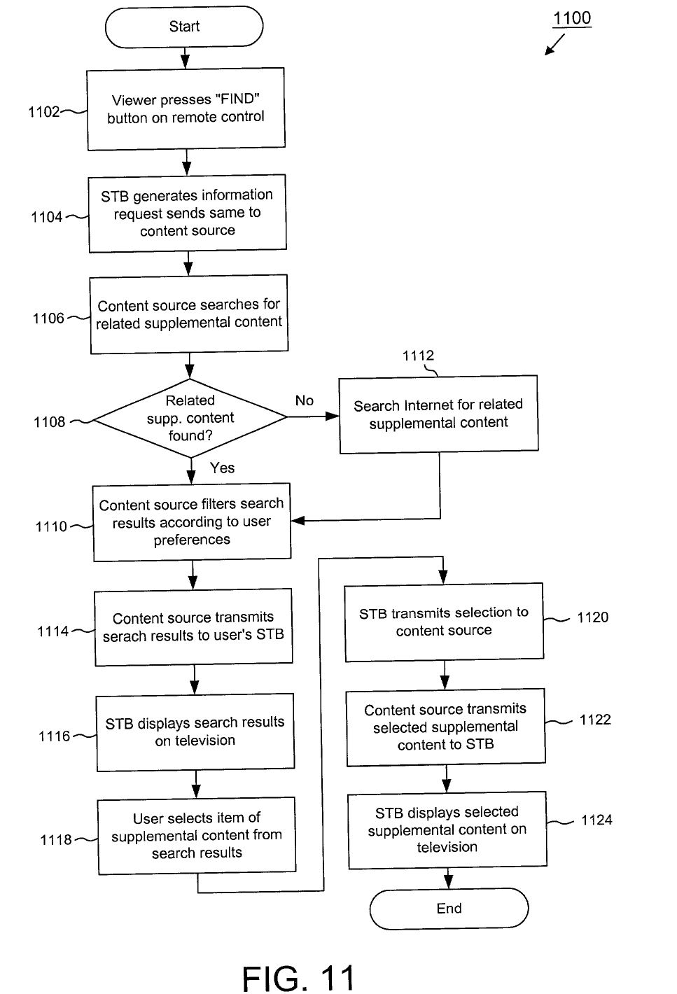

Referring now to FIG. 11, there is shown a flowchart of a method 1100 for unprompted, context-sensitive querying in an interactive television system 200. The method 1100 begins, in one embodiment, when the viewer presses 1102 a “FIND” button 240 on a remote control 106 while watching a television program 802. In response, an STB 102 generates 1104 an information request 502 containing, in one embodiment, contextual information 604 pertaining to the television program 802 (or segment thereof being viewed, and transmits the same to a supplemental content source 114.

In one embodiment, the content source 114 searches 1106 for related supplemental content 406 based on the contextual information 604 in the information request 502. If related supplemental content 406 is found at the content source 114 (e.g., search results 504), the content source 114 filters 1110 the set of search results 504 according to the user preferences 614 and/or user profile 704. If, however, related supplemental content 406 is not found 1108, the Internet 126 is searched 1112 for related supplemental content 406, after which a set of search results 504 from the Internet-based search is likewise filtered 1110 according to user preferences 614 or user profile 704.

Next, the content source 114 transmits 1114 the search results 504 to the user's STB 102, which displays 1116 the search results 504 on the television 104. A user selects 1118 an item of supplemental content 406 from the search results 504. Thereafter, the STB 102 transmits 1120 an indication 902 of the selection to the content source 114, which sends 1122 the selected supplemental content 406 to the STB 102. Finally, the STB 102 displays 1124 the selected supplemental content 406 on the television 104, after which the method 1100 is complete.

Based on the foregoing, the present invention offers numerous advantages not available in conventional approaches. For example, the present invention allows the user to initiate an unprompted, context-sensitive request 502 for supplemental content 406 at any time, even if the broadcaster or cable operator did not anticipate the user's interest. In addition, the present invention allows for a high degree of personalization, unlike conventional, trigger-based approaches.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A method for selectively retrieving and displaying supplemental content related to a television program being displayed by an interactive television system, the method comprising:
receiving a user command to find supplemental content;
obtaining contextual information pertaining to the television program being displayed;
sending an information request to a content source, the information request comprising the contextual information; and
in response to the content source identifying supplemental content related to the television program being displayed based upon the contextual information, retrieving the supplemental content from the content source for display by the interactive television system.

2. The method of claim 1, wherein the user command is received in response to a user activating a specifically-designated button on a remote control device for the interactive television system.

3. The method of claim 1, wherein the contextual information comprises an indication of the television program being displayed.

4. The method of claim 3, wherein obtaining comprises:
reading the indication of the television program from vertical blanking interval (VBI) data associated with the television program.

5. The method of claim 3, wherein obtaining comprises:
reading the indication of the television program from electronic programming guide (EPG) data associated with the television program.

6. The method of claim 3, further comprising:
searching the content source for supplemental content related to the indication of the television program.

7. The method of claim 1, wherein the contextual information comprises a time index.

8. The method of claim 7, wherein the time index indicates a time at which the user command is received.

9. The method of claim 7, further comprising:
searching the content source for supplemental content related to a particular time segment of the television program based upon the time index.

10. The method of claim 1, wherein the contextual information comprises at least one keyword obtained from closed-captioning text associated with the television program.

11. The method of claim 10, further comprising:
searching the content source for supplemental content comprising the at least one keyword.

12 The method of claim 11, further comprising:
in response to supplemental content comprising the at least one keyword not being found at the content source:
searching a global information network for supplemental content comprising the at least one keyword; and
retrieving the supplemental content from the global information network for display by the interactive television system.

13. The method of claim 1, further comprising:
in response to supplemental content related to the television program not being found at the content source:
searching a global information network for supplemental content related to the television program based on the contextual information; and
retrieving the supplemental content from the global information network for display by the interactive television system.

14. The method of claim 1, wherein the information request comprises an identifier of the interactive television system.

15. The method of claim 14, wherein the identifier comprises a media access control (MAC) address.

16. The method of claim 14, wherein the identifier comprises an Internet protocol (IP) address.

17. The method of claim 14, wherein retrieving comprises:
sending the identified supplemental content from the content source to an interactive television system associated with the identifier.

18. The method of claim 1, wherein the contextual information comprises an indication of a channel being displayed, the method further comprising:
using the indication the channel to identify a content source to receive the information request.

19. The method of claim 1, further comprising:
displaying the supplemental content simultaneously with the television program.

20. The method of claim 19, further comprising:
reducing the size of the displayed television program relative to the size of the displayed supplemental content.

21. The method of claim 1, wherein retrieving comprises:
receiving a list of supplemental content items from the content source in response to a search by the content source;
receiving a user selection of a supplemental content item from the list;
sending the user selection to the content source; and
retrieving from the content source the selected supplemental content item for display by the interactive television system.

22. The method of claim 21, wherein the list comprises at least one link to an item of supplemental content stored at the content source.

23. The method of claim 22, wherein the at least one link comprises a uniform resource locator (URL).

24. The method of claim 20, further comprising:
filtering the list of items of supplemental content results based on a set of user preferences.

25. The method of claim 24, wherein the information request comprises the set of user preferences.

26. The method of claim 24, wherein at least one user preference indicates a type of supplemental content to exclude.

27. The method of claim 24, wherein at least one user preference indicates a type of supplemental content preferred by the user.

28. The method of claim 24, wherein at least one user preference indicates a source of supplemental content preferred by the user.

29. The method of claim 24, wherein at least one user preference is stored in response to historical analysis of user selections from prior lists of items of supplemental content.

30. The method of claim 1, further comprising:
receiving a list of supplemental content items from the content source in response to a search of a global information network;
receiving a user selection of a supplemental content item from the list; and
retrieving from the global information network the selected supplemental content item for display by the interactive television system.

31. A system for selectively retrieving and displaying supplemental content related to a television program being displayed by an interactive television system, the system comprising:
a remote control device for the interactive television system, the remote control device comprising a specifically-designated button for requesting supplemental content related to the television program; and
a set top box for the interactive television system, the set top box being configured to obtain contextual information pertaining to the television program being displayed, send an information request comprising the contextual information to a content source, and retrieve supplemental content from the content source for display by the interactive television system in response to the content source identifying supplemental content related to the television program based upon the contextual information.

32. The system of claim 31, further comprising:
a display device for displaying the supplemental content retrieved from the content source.

33. The system of claim 31, wherein the contextual information comprises an indication of the television program being displayed.

34. The system of claim 33, wherein the set top box is further configured to read the indication of the television program from vertical blanking interval (VBI) data associated with the television program.

35. The system of claim 33, wherein the set top box is further configured to read the indication of the television program from electronic programming guide (EPG) data associated with the television program.

36. The system of claim 33, further comprising:
a search engine configured to search the content source for supplemental content related to the indication of the television program.

37. The system of claim 31, wherein the contextual information comprises a time index.

38. The system of claim 37, wherein the time index indicates a time at which the user command is received.

39. The system of claim 37, further comprising:
a search engine configured to search the content source for supplemental content related to a particular time segment of the television program based upon the time index.

40. The system of claim 31, wherein the contextual information comprises at least one keyword obtained from closed-captioning text associated with the television program.

41. The system of claim 40, further comprising:
a search engine configured to search the content source for supplemental content comprising the at least one keyword.

42 The system of claim 41, further comprising:
a search engine configured, in response to supplemental content comprising the at least one keyword not being found at the content source, to search a global information network for supplemental content comprising the at least one keyword;
wherein the set top box is further configured to retrieve the supplemental content from the global information network for display by the interactive television system.

43. The system of claim 31, further comprising:
a search engine configured, in response to supplemental content related to the television program not being found at the content source, to search a global information network for supplemental content related to the television program based on the contextual information; and
wherein the set top box is further configured to retrieve the supplemental content from the global information network for display by the interactive television system.

44. The system of claim 31, wherein the information request comprises an identifier of the interactive television system.

45. The system of claim 44, wherein the identifier comprises a media access control (MAC) address.

46. The system of claim 44, wherein the identifier comprises an Internet protocol (IP) address.

47. The system of claim 44, wherein the content source is configured to send the identified supplemental content to an interactive television system associated with the identifier.

48. The system of claim 31, wherein the contextual information comprises an indication of a channel being displayed, and wherein the set top box is further configured to use the indication the channel to identify a content source to receive the information request.

49. The system of claim 31, wherein set top box is configured to simultaneously display the supplemental content with the television program.

50. The system of claim 49, wherein the set top box is further configured to reduce the size of the displayed television program relative to the size of the displayed supplemental content.

51. The system of claim 31, wherein the set top box is further configured to receive a list of supplemental content items from the content source in response to a search by the content source, receive a user selection of a supplemental content item from the list, send the user selection to the content source, and retrieve from the content source the selected supplemental content item for display by the interactive television system.

52. The system of claim 51, wherein the list comprises at least one link to an item of supplemental content stored at the content source.

53. The system of claim 52, wherein the at least one link comprises a uniform resource locator (URL).

54. The system of claim 50, further comprising:
a filtering component configured to filter the list of items of supplemental content results based on a set of user preferences.

55. The system of claim 54, wherein the information request comprises the set of user preferences.

56. The system of claim 54, wherein at least one user preference indicates a type of supplemental content to exclude.

57. The system of claim 54, wherein at least one user preference indicates a type of supplemental content preferred by the user.

58. The system of claim 54, wherein at least one user preference indicates a source of supplemental content preferred by the user.

59. The system of claim 54, wherein at least one user preference is stored in response to historical analysis of user selections from prior lists of items of supplemental content.

60. The system of claim 31, wherein the set top box is further configured to receive a list of supplemental content items from the content source in response to a search of a global information network, receive a user selection of a supplemental content item from the list, and retrieve from the global information network the selected supplemental content item for display by the interactive television system.
